(19) United States
(12) Patent Application Publication
(10) Pub. No.: US 2026/0352774 A1
(43) Pub. Date: Nov. 5, 2026

(54) METHOD FOR JOB-SPECIFIC PROFILING A DIGITAL PRINTER

(71) Applicant: Esko Software BV, Gent (BE)

(72) Inventors: Dries VANDENBUSSCHE, Gent (BE); Rian GOOSSENS, Lokeren (BE)

(73) Assignee: Esko Software BV, Gent (BE)

(21) Appl. No.: 19/486,759

(22) PCT Filed: May 23, 2024
(86) PCT No.: PCT/EP2024/064284

§ 371 Date: Nov. 21, 2025

Related U.S. Application Data
(60) Provisional application No. 63/468,734, filed on May 24, 2023.
(60) Provisional application No. 63/468,988, filed on May 25, 2023.

(51) Int. Cl. H04N 1/60; H04N 1/00

(52) U.S. Cl. CPC H04N 1/6044; H04N 1/00015; H04N 1/00034; H04N 1/00045; H04N 1/00087

(57) ABSTRACT

A computer-implemented method for calibrating printing color output of a printer. The method includes the following steps. Receiving a print job file, the print job file including one or more print colors. Preparing a calibration ink chart, the calibration ink chart including one or more calibration colors. Printing the calibration ink chart via the printer as a preprinting calibration sheet, the preprinting calibration sheet printed with preprinted colored ink.

Measuring a respective preprinted color of the preprinted colored ink on the preprinting calibration sheet via a spectrophotometer coupled to the printer. Comparing the measured respective preprinted color to a respective calibration color of the calibration colors. Based on the comparison between the measured respective preprinted color to the respective calibration color, adjusting the printer to decrease the difference between the measured respective preprinted color and the respective calibration color. Printing a print job as described by the print job file.

### CROSS REFERENCE TO RELATED APPLICATIONS

This invention claims priority from U.S. Provisional Application Ser. No. 63/468,988, filed May 25, 2023, and U.S. Provisional Application Ser. No. 63/468,734, filed May 24, 2023, both titled METHOD FOR JOB-SPECIFIC PROFILING A DIGITAL PRINTER and both incorporated herein by reference in their entireties.

### TECHNICAL FIELD

The present subject matter relates to techniques and equipment to a method for physical-sample-based color profiling at a print job level.

### BACKGROUND OF THE INVENTION

Color profiling is an important process for ensuring consistent color in printed product (e.g. packaging). Even if a printer is originally perfectly calibrated, differing printing mediums and ink sources can produce color that is not true to the color described in a print job (i.e. a request to print a product). Additionally, as the printer ages, consumable parts wear and degrade, resulting in color changes.

For industrial-scale printing operations, printer downtime is extremely costly. Many printer operators do not have the time to troubleshoot color correction on behalf of on individual print jobs: if the colors coming out of a printer are consistently incorrect, many operators simply replace all of the consumable parts in that printer, and neither troubleshoot which consumable parts actually require replacement, nor adjust the printer to compensate for the color changes. Likewise, for a given print job, often a closest reference print condition is identified, where the print condition in this context is primarily concerned with printing medium material and printing medium color. However, if the printing medium differs from the reference print condition, for example by being a slightly more absorbent paper, many printer operators simply print regardless using that closest reference print condition as a basis, and place clients in the position of either ordering reprints, or correcting their print jobs to compensate for the difference between the printing medium and the reference print condition.

Profiling the printer before each job, or at least each job where the printing medium differs from the closest reference print condition, would largely resolve these issues. In traditional profiling, a sample sheet of every color the printer is capable of printing is generated, and then each color is checked by a spectrophotometer to verify color correctness, or to identify difference between a requested digital color and the corresponding printed physical ink color. As previously noted, however, printer downtime is extremely costly. Printing a sample sheet, and stopping the printer while the spectrophotometer operates and corrections to the profile are applied, consumes a large amount of valuable printing time, which printer operators will not tolerate.

Hence, there is a need to improve color profiling during operation of printers, and in particular improvement is needed for color profiling on a per-print job basis.

### SUMMARY OF INVENTION

One aspect of the invention relates to a computer-implemented method for calibrating printing color output of a printer. The method includes the steps of: receiving a print job file, the print job file including one or more print colors; preparing a calibration ink chart, the calibration ink chart including one or more calibration colors; printing the calibration ink chart via the printer as a preprinting calibration sheet; and measuring a respective preprinted color of the calibration ink chart on the preprinting calibration sheet via a spectrophotometer coupled to the printer. The measured respective preprinted color is compared to a respective calibration color of the calibration colors. Based on the comparison between the measured respective preprinted color to the respective calibration color, the printer is adjusted to decrease the difference between the measured respective preprinted color and the respective calibration color, and then the print job is printed as described by the print job file.

Another aspect of the invention relates to a printing calibration system. The printing calibration system includes a printer, a processor coupled to the printer, a spectrophotometer coupled to the processor, and a memory coupled to the processor. The printing calibration system also includes machine-readable instructions embodying programming in the memory, wherein execution of the programming by the processor configures the printing calibration system to perform functions. The printing calibration system receives a print job file, the print job file including one or more print colors. The printing calibration system prepares a calibration ink chart, the calibration ink chart including one or more calibration colors. The printing calibration system prints the calibration ink chart via the printer as a preprinting calibration sheet. The printing calibration system measures a respective preprinted color of the calibration ink chart on the preprinting calibration sheet via the spectrophotometer. The printing calibration system compares the measured respective preprinted color to a respective calibration color of the calibration colors. Based on the comparison between the measured respective preprinted color to the respective calibration color, the printing calibration system adjusts the printer to decrease the difference between the measured respective preprinted color and the respective calibration color. The printing calibration system prints a print job as described by the print job file.

### BRIEF DESCRIPTION OF THE DRAWINGS

The drawing figures depict one or more implementations, by way of example only, not by way of limitations. In the figures, like reference numerals refer to the same or similar elements.

FIG. 1 is a block diagram of a printing calibration system, including a printer and an inline spectrophotometer.

FIG. 2 is a flowchart of the job-specific profiling protocol used to perform job specific printer profiling.

### DETAILED DESCRIPTION OF THE INVENTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

Reference now is made in detail to the examples illustrated in the accompanying drawings and discussed below.

The term “spectrophotometer” is inclusive of spectrometers, spectrally precise cameras or scanners, colorimeters, and equivalent sensing equipment.

Although the term “scanned image” is used herein, this term should be understood to refer to the image containing measured values, regardless of technology used to obtain the measured values. Measured values are generally collected in a table of data points from the sample. These data points can be manually defined, or may be automatically defined by an algorithm.

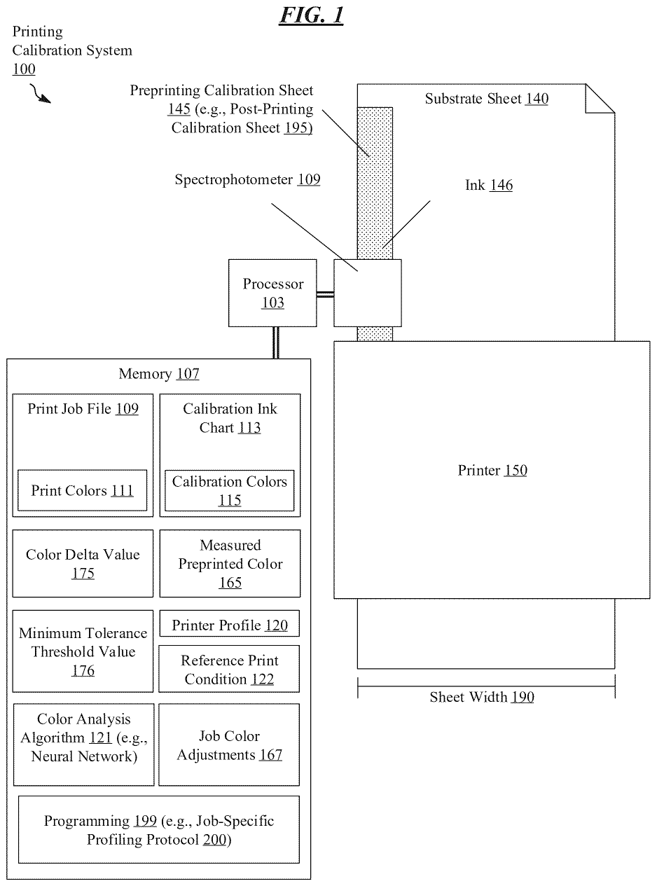

FIG. 1 is a block diagram of a printing calibration system 100, including a printer 150 and an inline spectrophotometer 108. printing calibration system 100 as depicted comprises a printer 150, which is configured to receive a graphics file comprising one or more print colors 111, and an associated reference electronic print job file 109. The graphics file may be in a variety of formats, such as a joint photographic experts group (JPEG) file, a portable network graphics (PNG) file, or a portable document format (PDF) file. The associated reference electronic print job file 109 may include, without limitation, the ultimate size of a printed image, resolution, and the ink color model, as well as the total number of prints per image to be pressed. Any instructions that may assist the printer 150 may be included in the reference electronic print job file 109. Reference to printing the graphics file within the print job file 109, and printing the print job file 109, are used interchangeably throughout, and refers to printing the graphics file within the print job file 109.

The substrate sheet 140 is the substrate upon which the printer 150 prints the print colors 111 associated with the reference electronic print job file 109 to form a graphic. The substrate sheet 140 may be, for example, paper, metal, wood, plastic, cloth, ceramic, or a composite of one or more materials. If paper, the substrate sheet 140 may be a particular type of paper: for example, glossy or matte, thick or thin, and synthetic or recycled. In addition to the substrate sheet 140, the printer 150 may have a standardized printer profile 120. The printer profile 120 may define whether the print will be coated, and what the print will be coated with; in addition, the printer profile 120 may select particular inks based upon the print colors 111 requested by the reference electronic print job file 109. Ideally, the printer profile 120 should reflect and integrate the physical features of the substrate sheet 140, as well as the particular implementation features of the printer 120, such as ink colors and types, and whether the printer is a dot matrix, inkjet, laser, or other type of printer. The printer profile may rely on a reference print condition 122, which is referential information for printing on commonly used substrate sheets 140: for example, a reference print condition 122 may include additional information for printing on glossy paper, or matte paper, or metal such as aluminum. If a reference print condition 122 is not available that is identical to a description of the substrate sheet 140, then the closest reference print condition 122 is often used (e.g., the substrate sheet 140 is stainless steel, and the closest reference print condition 122 describes aluminum-no other reference print condition in this example describes a metal substrate: in such an example, the aluminum reference print condition 122 will often be used to print on the stainless steel substrate sheet 140.)

The source printer 150 receives the reference electronic print job file 109, the printer profile 150, and any reference print condition 122 digitally, and receives the substrate sheet 140 as a physical input. The printer 150 applies modifications of the printer profile 120 and the reference print condition 122 to the reference electronic print job file 109, and prints upon the substrate sheet 140 exactly as the reference electronic print job file 109 describes. Therefore, the printer 150 prints ink on the substrate sheet 140 in accordance with the electronic print job file 109, the printer profile 150, and any reference print condition 122, resulting in a printed embodiment.

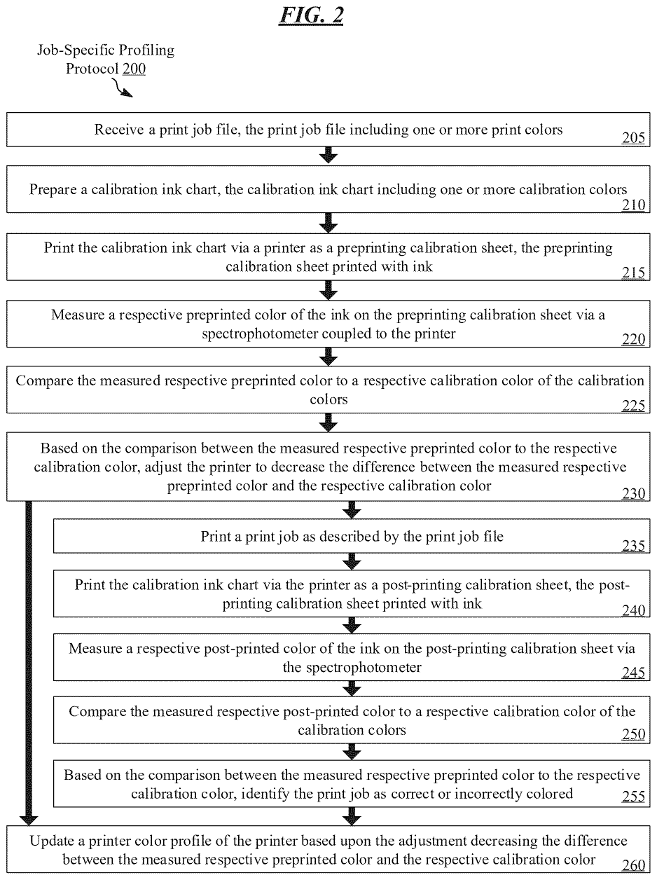

The printed embodiment is what is expected to match the print job file 109, and in particular the print colors 111 of the electronic print job file 109. In the printing calibration system 100, to ensure the printed embodiment is as close to what is described in the electronic print job file 109, with respect to the print colors 111, the job-specific profiling protocol 200 (see FIG. 2) is implemented.

In brief, the job-specific profiling protocol 200 requires generating a calibration ink chart 113 made up of calibration colors 115. The calibration colors 115 include some or all of the print colors 111. The calibration ink chart 115 is printed by the printer 150 on the substrate sheet 140 before the electronic print job file 109 is printed. When printed on the substrate sheet 140, the calibration ink chart 115 made up of physical inks 146 on the substrate sheet 140 is called the preprinting calibration sheet 145. The preprinting calibration sheet 145 is scanned by a spectrophotometer 108, with the results stored as measured preprinted color 165. The printing calibration system 100 derives adjustments to the colors in the printer profile 120 based on the measured preprinted color 165 (and the reference print condition 122 if utilized), and stores those adjustments as job color adjustments 167. The colors adjustments 167 may be derived using a color analysis algorithm 121. Finally, the printer 150 applies the job color adjustments 167 to the print colors 111 of the print job file 109, and the printer 150 prints ink on the substrate sheet 140 in accordance with the electronic print job file 109, the printer profile 150, any reference print condition 122, and the job color adjustments, resulting in a printed embodiment which is expected to have truer color than a printed embodiment where the job-specific profiling protocol 200 is not used.

The printer 150 may be a digital press, proofer, or other types of printer. Additionally, in some examples the printer 150 may be a computer display. In such examples, the printed embodiment is an image displayed upon the computer display. These examples utilizing the computer display are particularly useful for system testing and diagnostics for other physical printers.

A spectrophotometer 108 captures an image of the substrate sheet 140, and in particular the preprinting calibration sheet 145. The spectrophotometer 108 can be mounted in a fixed position, and does not need to have a view across the entire sheet width 190 in order to perform color analysis for job-level profiling purposes. The preprinting calibration sheet 145 can be printed as wide as the spectrophotometer 108 is able to scan: as compared to a traditional calibration sheet, the preprinting calibration sheet 145 may be longer, but should be much less wide, and require a much less elaborate spectrophotometer 108. The lighting conditions should be controlled when the spectrophotometer 108 captures the image of the preprinting calibration sheet 145, (e.g. under a diffuse light in a windowless room). That captured image is converted into measured preprinted color 165, which is information describing the ink 146 on the substrate as printed.

The spectrophotometer 108 readings are preferably stored as measured preprinted color 165 automatically, though doing so manually is contemplated. The spectrophotometer 108 is connected to the processor 103 that also has access to the calibration ink chart 113, with points on the calibration ink chart 113 registered in a coordinate system corresponding to a like coordinate system in the preprinting calibration sheet 145, and the spectrophotometer 108 location and objects within the view of the spectrophotometer 108 tracked in real time, so that the readings taken as measured preprinted color 165 by the spectrophotometer 108 map to the corresponding calibration colors 115 in the calibration ink chart 113.

The areas of ink 146 matching the calibration colors 115 may overlap numerous print colors 111. The print colors 111 can be sampled to collect the ink combinations overlapped by the areas, either as the center of the areas, or as an average of the whole area. These specific points can be scanned automatically by feeding the positions to the spectrophotometer 108 having coordinates relative to the preprinting calibration sheet 145 registered in correspondence to like coordinates on the calibration ink chart 113.

Calibration colors 115 for colorimetric measurements of the preprinting calibration sheet 145 may be selected by any number of factors, preferably strategically based upon the print colors 111 in the print job file 109, such as selecting colors most frequently utilized, colors corresponding to single ink values, colors corresponding to minima and/or maxima for one or more of the ink colors, critical design colors (e.g. brand colors or spot colors), solid rendering colors, and the like, without limitation. For example, with respect to the minima and/or maxima, the solid color of the ink may be set as a maximum, and the color of the printing substrate may be set as a minimum, thereby providing a minima that is common for every color.

Other image capturing devices can also be used to capture measured values of the sample. For example, if sRGB is an adequate intermediate space, rather than using a spectrophotometer 108, the system may simply use scanner or camera to capture an image of the package. The system then aligns this image with a render of the job using techniques such as SIFT, ORB or SURF, and then records the values of identified pixels, each of which includes a pair of ink values (the input space) and an RGB value (the intermediate space). In this technique, RGB values may be averaged if their corresponding ink values are the same. Alternatively, if a full spectral scanner is available with acceptable spectral quality, information may be directly determined by scanning the sample using such a scanner.

In this example, the preprinting calibration sheet 145 is depicted as part of a substrate sheet 140 as wide as the sheet width 190. In some examples, the preprinting calibration sheet 145 may be a separate substrate, may feed separately into the printer 150, and may not need to be as wide as the full sheet width 190.

Once the measured preprinted color 165 is collected, the printing calibration system 100 includes a computer processor 103 to create job color adjustments 167. The computer processor 103 uses a color analysis algorithm 121 to determine appropriate adjustments to the printer 150. As “overshooting” color can be as incorrect as “undershooting” color, the adjustments in some examples may be skipped. A color delta value 175 is calculated for each color in the calibration colors 115 paired with each resulting measured preprinted color 165. The color delta value 175 represents the difference between a given calibration color 115 and the paired measured preprinted color 165. If the color delta value is too small 175, meaning that the calibration color 115 and the measured preprinted color 165 are very close, an adjustment may not be made: at small color delta values 175, even small adjustments may be too large, and can result in larger color delta values 175 in that same pairing. A color that is not cyan enough, but nevertheless barely (e.g., Δ=−0.005) adjusted by the smallest amount the printer 150 is capable of adjusting, may end up being too cyan (e.g., Δ=0.1) when the print job file 109 is actually printed. To avoid this, multiple successive preprinting calibration sheets 145 can be printed, in order to reduce the color delta values 175 with successively finer adjustments. Alternatively, a minimum tolerance threshold value 176 can be set, and color delta values 175 lower than the minimum tolerance threshold value 176 do not result in an adjustment of the print colors 111 based on the relevant measured preprinted color 165.

In order to improve quality control, a post-printing calibration sheet can also be printed 145. After preprinting the calibration ink chart 113, and printing the job file 109 implementing the job color adjustments 167, a post-printing calibration ink chart can be printed as a post-printing calibration sheet 195. The post-printing calibration sheet 195 includes the calibration colors 115, modified based on the job color adjustments 167. If the post-printing calibration sheet 195 has proper coloring, as determined by the spectrophotometer 108 or an operator, then it is highly likely that every print between the preprinting calibration sheet 149 and the post-printing calibration sheet 195 has proper coloring. Consequently, the substrate sheets 140, when printed on, can omit a quality control strip-some conventional printing systems use a quality control strip on each or a selection of prints in a batch, which are then checked for color accuracy. By ensuring proper color before printing the print job file 109, and confirming proper color after printing the print job file 109, proper color can be fairly assumed on the prints of the print job file 109.

Alternatively, a calibration ink chart 113 can be printed as a post-printing calibration sheet 195 with identical instructions as the calibration ink chart 113 printed as a preprinting calibration sheet 145. If the measured preprinted color 165 from the preprinting calibration sheet 145 is nearly identical to the measured post-printed color from the post-printing calibration sheet 195, then the printer 150 has not varied over the course of printing the print job file 109, and the entire print job file 109 is uniform in color correctness.

Processor 103 serves to perform various operations, for example, in accordance with instructions or programming executable by the computer processor 103. For example, such operations may include operations related to communications between different graphics file printing components, or for transforming graphics files into other formats. Although the processor 103 may be configured by use of hardwired logic, typical processors 103 may be general processing circuits configured by execution of programming. The processor 103 includes elements structured and arranged to perform one or more processing functions, typically various data processing functions. Although discrete logic components may be used, the examples utilize components forming a programmable CPU. The processor 803, for example, may include one or more integrated circuit (IC) chips incorporating the electronic elements to perform the functions of the CPU. The processor 103, for example, may be based on any known or available microprocessor architecture, such as a Reduced Instruction Set Computing (RISC) using an ARM architecture, commonly used in mobile devices and other portable electronic devices. The processor 103 includes or has access to enough storage (including the memory 107) to store at least the reference electronic job file 109, the measured preprinted color 165, job color adjustments 167, and instructions to implement the color analysis algorithm 121. Of course, other processor circuitry may be used to form the processor 103.

An interface for performing the methods as described may be, for example and without limitation, a touchscreen device where print job instructions are inputted via a user interface application through manipulation or gestures on a touch screen. For output purposes, the touch screen of the user interface and file intake includes a display screen, such as a liquid crystal display (LCD) or light emitting diode (LED) screen or the like. For input purposes, a touch screen includes a plurality of touch sensors.

In other embodiments, a keypad may be implemented in hardware as a physical keyboard of the user interface and file intake, and keys may correspond to hardware keys of such a keyboard. Alternatively, some or all of the keys (and keyboard) may be implemented as “soft keys” of a virtual keyboard graphically represented in an appropriate arrangement via touch screen. The soft keys presented on the touch screen may allow the user to invoke the same user interface functions as with the physical hardware keys. The user interface is not limited to any particular hardware and/or software for facilitating user input, however. The user interface and file intake may have a graphical interface, such as a screen, and tactile interfaces, like a keyboard or mouse. It may also have a command line interface that allows for text input commands. The user interface and file intake may also have a port to accept a connection from an electronic device containing a graphics file to be printed.

Therefore, FIG. 1 depicts a printing calibration system 100, including a printer 150, a processor 103 coupled to the printer 150, a spectrophotometer 108 coupled to the processor 103, and a memory 107 coupled to the processor 103. The printing calibration system 100 also includes machine-readable instructions embodying programming 199 in the memory 107, wherein execution of the programming 199 by the processor 103 configures the printing calibration system 100 to perform functions. The printing calibration system 100 receives a print job file 109, the print job file 109 including one or more print colors 111. The printing calibration system 100 prepares a calibration ink chart 113, the calibration ink chart 113 including one or more calibration colors 115. The printing calibration system 100 prints the calibration ink chart 113 via the printer 150 as a preprinting calibration sheet 145, the preprinting calibration sheet 145 printed with ink 146. The printing calibration system 100 measures a respective preprinted color of the ink 146 on the preprinting calibration sheet 145 via the spectrophotometer 108. The printing calibration system 100 compares the measured respective preprinted color 165 to a respective calibration color of the calibration colors 115. Based on the comparison between the measured respective preprinted color 165 to the respective calibration color 115, the printing calibration system 100 adjusts the printer 150 to decrease the difference between the measured respective preprinted color 165 and the respective calibration color 115. The printing calibration system 100 prints a print job as described by the print job file 109.

In some examples, the respective preprinted color of the ink 146 is intended at the time of printing to be substantially identical to the respective calibration color of the calibration colors 115 when measured by the spectrophotometer 108.

In some examples, the calibration colors 115 include each print color 111. In other examples, the calibration colors 115 include only the one or more print colors 111. In still other examples, the calibration colors 115 include one or more dominant colors of the print colors 111. Colors that are minimally utilized, or are very close in color to other colors that are used generously, are not dominant colors; colors that are used generously throughout the print job file 109, or are very divergent in color from other colors in the print colors 111, are dominant colors. Often, only dominant colors need to be calibrated, as non-dominant colors will either be incidentally calibrated by calibrating the dominant color, or errors in the non-dominant color do not qualify the final print as a failure or materially incorrect.

In some examples, a calibration color has two or more patterns of ink combinations able to achieve a successful print of the calibration color. A first pattern of the two or more patterns of ink combinations is used when printing the preprinting calibration sheet and the first pattern is used when printing the calibration color during printing of the print job. Within a digital printer 150, there can be multiple ink ratios which can achieve the same color. Rather than test each possible ink ratio that a printer 150 could use to achieve a certain color, the printing calibration system 100 can select one ink ratio when preparing the preprinting calibration ink chart 113, and afterward when printing the print job file 109, control the printer to use that same ink ratio, and not another ink ratio.

In some examples, printing the calibration ink chart 113 via the printer 150 as a preprinting calibration sheet 145 includes printing an overprint color pattern present in the print job file 109 and a respective preprinted color is the overprint color pattern. The printing calibration system 100 is capable of checking overprint ink colors, whereas other conventional color correction systems are configured to only check spot colors.

In some examples, the printer 150 has a sheet width 190, and the spectrophotometer 108 is configured to scan a scanner area narrower than the sheet width 190. In some of those examples, the spectrophotometer 108 is fixed in position. In other related examples, the scanner area has a width of less than 25% of the sheet width.

In some example, the print job file 109 describes printing two or more sheets 140, and each sheet 140 of the two or more sheets 140 omits a quality-control strip. When checking color correctness before and after printing a print job file 109, checking color correctness during the printing of a print job file 109 can be avoided.

In some examples, execution of the programming 199 by the processor 103 further configures the printing calibration system 100 to perform functions. After printing the print job 109, the printing calibration system 100 print the calibration ink chart 113 via the printer as a post-printing calibration sheet 195. The printing calibration system 100 measures a respective post-printed color of the calibration ink chart 113 on the post-printing calibration sheet 195 via the spectrophotometer 108. The printing calibration system 100 compares the measured respective post-printed color to a respective calibration color of the calibration colors 115. Based on the comparison between the measured respective post-printed color to the respective calibration color, the printing calibration system identifies the print job as correct or incorrectly colored.

In some examples, comparing the measured respective preprinted color 165 to the respective calibration color 115 generates a color delta value 175, the color delta value 175 representing the amount of difference between the respective preprinted color 165 and the respective calibration color 115 as determined by a spectrophotometer 108. The adjustment of the printer 150 to decrease the difference between the measured respective preprinted color 165 and the respective calibration color 115 occurs based on the comparison between the measured respective preprinted color 165 to the respective calibration color 115 and the color delta value 175 exceeding a minimum tolerance threshold value 176. The adjustment of the printer 150 to decrease the difference between the measured respective preprinted color 165 and the respective calibration color 115 is preferably performed by adjusting the print colors 111 of the print job file 109 that is used by the printer 150 in printing the colors specified by the print job file 109.

In some examples, the adjustment of the printer 150 to decrease the difference between the measured respective preprinted color 165 and the respective calibration color 115 targets an intermediary color between the measured respective preprinted color 165 and the respective calibration color 115.

In some examples, execution of the programming 199 by the processor 103 further configures the printing calibration system 100 to perform functions. The printing calibration system 100 updates a printer color profile 120 of the printer 150 based upon the adjustment decreasing the difference between the measured respective preprinted color 165 and the respective calibration color 115. In cases where the printer 150 is rarely re-profiled, or preprinting calibration was performed on a substrate identical to a reference print condition 122 and a color delta value 175 is found, or a particular color has a high color delta value 175 consistently and independent of substrate selection, adjustments to the printer profile 120 itself can be made, rather than to the single print job file 109.

In some examples, the adjustment decreasing the difference between the measured respective preprinted color 165 and the respective calibration color 115 is performed by a neural network 121.

FIG. 2 is a flowchart of the job-specific profiling protocol 200 used to perform job specific printer profiling. In step 205, a printing calibration system 100 receives a print job file 109, the print job file 109 including one or more print colors 111. In step 210, the printing calibration system 100 prepares a calibration ink chart 113, the calibration ink chart 113 including one or more calibration colors 115. In step 215, the printing calibration system 100 prints the calibration ink chart 113 via a printer 150 as a preprinting calibration sheet 145. In step 220, the printing calibration system 100 measures a respective preprinted color of the calibration ink chart 113 on the preprinting calibration sheet 145 via a spectrophotometer 108 coupled to the printer 150. In step 225, the printing calibration system 100 compares the measured respective preprinted color 165 to a respective calibration color 115 of the calibration colors 115. In step 230, the printing calibration system 100, based on the comparison between the measured respective preprinted color 165 to the respective calibration color 115, adjusts the printer 150 to decrease the difference between the measured respective preprinted color 165 and the respective calibration color 115. From step 230, the job specific profiling protocol 200 can proceed to step 235, or to step 260.

In step 235, the printing calibration system 100 prints a print job as described by the print job file 109. The job specific profiling protocol 200 can end at step 235, or continue to step 240. In step 240, the printing calibration system 100 print the calibration ink chart 113 via the printer 150 as a post-printing calibration sheet 195. In step 245, the printing calibration system 100 measures a respective post-printed color of the calibration ink chart 113 on the post-printing calibration sheet 195 via the spectrophotometer 108. In step 250, the printing calibration system 100 compares the measured respective post-printed color to a respective calibration color 115 of the calibration colors 115. In step 255, the printing calibration system 100, based on the comparison between the measured respective preprinted color to the respective calibration color 115, identifies the print job as correct or incorrectly colored. The job specific profiling protocol 200 can end at step 255, or continue to step 260.

In step 260, the printing calibration system 100 updates a printer color profile 120 of the printer 150 based upon the adjustment decreasing the difference between the measured respective preprinted color 165 and the respective calibration color 115, or based upon the adjustment decreasing the difference between the measured respective post-printed color and the respective calibration color 115.

To the extent this disclosure refers to the printer applying the color adjustments or adjusting the printer to make adjustments in color, it should be understood to one of skill in the art that the adjustments may be made by any means available, but that the typical exemplary mechanism by which a printer makes such an adjustment is through adjustments made to the color profile used by the printer, as discussed elsewhere herein. In particular, the color profile may be expressed in a PDF corresponding to the job file that is sent to the printer for printing. As is understood by those of skill in the art, the color profile is used by the printer to convert job color information to printer command information that results in the printer applying specific amounts/patterns of one or more inks to render the specified color on the substrate within a desired tolerance. To the extent the disclosure references a printer calibration system, it should be understood that such systems typically also calibrate the printer by adjusting the color profile. Aspects of the invention include modification of the PDF file to be printed for a specific job, based upon color calibration of the printer using a calibration chart derived especially for that job using a subset of colors derived from job-specific information regarding dominant, frequent, and/or important colors found in the job. Aspects of the invention including using a reference color space (e.g. Lab) to measure and identify the job-relevant colors.

### EXAMPLE

Aspects of the invention generally relate to the step between Lab and output color space. A PDF (or other file format used for defining the information used by the printer for printing the job) is defined in a color space defined by a profile (usually called an input profile). Designs may, for example, be expressed in an “isocoated” color profile. The input profile may also be the output profile of a flexo press, such as used for simulation printing. The input profile is used together with ink profiles to determine the Lab color values at each position in the PDF.

The colors in the PDF are then defined in the reference colorspace (e.g. Lab), and the important colors in the reference colorspace are identified. A pre-existing output profile is then used to convert the identified important colors, and those colors are printed and measured using the calibration chart, as described herein. Deviations between measured color values and the desired color values are noted, and the output profile (or portions thereof) are modified to eliminate or reduce the deviations. Notably, the printer does not use the output profile; rather, the output profile is a description of how the press prints (i.e. the resulting true colors produced by that printer). The calibration process will make the output profile more up to date in the regions that are relevant for the current job.

The new output profile is used for converting the PDF, which is then printed using the printer (which itself is not modified at all). As a more specific example, a position in the PDF defined in isocoated as 50% cyan may be converted to Lab color using the isocoated profile to find 78.12-21.88-28.48. Converting this back to the current output profile might yield, for example, 48% cyan+5% magenta. This value is printed and measured, the resulting Lab is 80.12-21.88-28.48. This measured value is too light, meaning the output profile is lighter than expected, so an adjustment may be made to print, for example, 52% cyan +7% magenta.

In summary, there are 2 profiles: input and output, and the final results are calculated as:
Ink % in PDF+Input profile-→Lab
Lab+Modified output profile (or Lab+calibration+old output profile)>Ink % of press

willThe instructions, programming, or application(s) may be software or firmware used to implement any other device functions associated with the printer 150, processor 103, or spectrophotometer 108. Program aspects of the technology may be thought of as “products” or “articles of manufacture” typically in the form of executable code or process instructions and/or associated data that is stored on or embodied in a type of machine or processor readable medium (e.g., transitory or non-transitory), such as a memory of a computer used to download or otherwise install such programming into the printer 150, processor 103, spectrophotometer 108, or a transportable storage device or a communications medium for carrying program for installation in the printer 150, processor 103, or spectrophotometer 108. Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

The PCs, printers and scanners described throughout the specification include but are not limited to processor 600 (e.g. CPU) for performing the scanning algorithms, processing algorithms and printing algorithms, memory 107 for storing data and programming instructions for supporting the operation of processor 103, spectrophotometer 108 for scanning the physical sample, user input/output (e.g. buttons, switches, display screens, etc.) for receiving instructions from the user and providing feedback to the user, printer 150 (e.g. proofer, inkjet printer, press printer, etc.) for printing the physical samples, and any transceivers (e.g. wired, wireless, Bluetooth, WiFi, etc.) for communication between the devices.

The instructions, programming, or application(s) may be software or firmware used to implement the device functions associated with the device such as the scanners, printers and PCs described throughout this description. Program aspects of the technology may be thought of as “products” or “articles of manufacture” typically in the form of executable code or process instructions and/or associated data that is stored on or embodied in a type of machine or processor readable medium (e.g., transitory or non-transitory), such as a memory of a computer used to download or otherwise install such programming into the source/destination PC and/or source/destination printer.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

It should be understood that all of the figures as shown herein depict only certain elements of an exemplary system, and other systems and methods may also be used. Furthermore, even the exemplary systems may comprise additional components not expressly depicted or explained, as will be understood by those of skill in the art. Accordingly, some embodiments may include additional elements not depicted in the figures or discussed herein and/or may omit elements depicted and/or discussed that are not essential for that embodiment. In still other embodiments, elements with similar function may substitute for elements depicted and discussed herein.

Any of the steps or functionality of the system and method for converting graphic files for printing can be embodied in programming or one more applications as described previously. According to some embodiments, “function,” “functions,” “application,” “applications,” “instruction,” “instructions,” or “programming” are program(s) that execute functions defined in the programs. Various programming languages may be employed to create one or more of the applications, structured in a variety of manners, such as object-oriented programming languages (e.g., Objective-C, Java, or C++), procedural programming languages (e.g., C or assembly language), or firmware. In a specific example, a third party application (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating systems. In this example, the third party application can invoke API calls provided by the operating system to facilitate functionality described herein.

Hence, a machine-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that has, comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like, whether or not qualified by a term of degree (e.g. approximate, substantially or about), may vary by as much as ±10% from the recited amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected may lie in less than all features of any single disclosed example. Hence, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A computer-implemented method for calibrating printing color output of a printer, the method comprising:
receiving a print job file, the print job file including one or more print colors;
preparing a calibration ink chart, the calibration ink chart including one or more calibration colors;
printing the calibration ink chart via the printer as a preprinting calibration sheet;
measuring a respective preprinted color of the calibration ink chart on the preprinting calibration sheet via a spectrophotometer coupled to the printer;
comparing the measured respective preprinted color to a respective calibration color of the calibration colors;
based on the comparison between the measured respective preprinted color to the respective calibration color, adjusting the printer to decrease the difference between the measured respective preprinted color and the respective calibration color;
printing a print job as described by the print job file.

2. The computer-implemented method of claim 1, wherein the respective preprinted color is intended at the time of printing to be substantially identical to the respective calibration color when measured by the spectrophotometer.

3. The computer-implemented method of claim 1, wherein the calibration colors include each print color.

4. The computer-implemented method of claim 1, wherein the calibration colors include only the one or more print colors.

5. The computer-implemented method of claim 1, wherein the calibration colors include one or more dominant colors of the print colors.

6. The computer-implemented method of claim 1, wherein:
a calibration color has two or more patterns of ink combinations able to achieve a successful print of the calibration color;
a first pattern of the two or more patterns of ink combinations is used when printing the preprinting calibration sheet; and
the first pattern is used when printing the calibration color during printing of the print job.

7. The computer-implemented method of claim 1, wherein:
printing the calibration ink chart via the printer as a preprinting calibration sheet includes printing an overprint color pattern present in the print job file; and
the respective preprinted color is the overprint color pattern.

8. The computer-implemented method of claim 1, wherein:
the printer has a sheet width;
the spectrophotometer is configured to scan a scanner area narrower than the sheet width.

9. The computer-implemented method of claim 8, wherein:
the spectrophotometer is fixed in position.

10. The computer-implemented method of claim 8, wherein:
the scanner area has a width of less than 25% of the sheet width.

11. The computer-implemented method of claim 1, wherein:
the print job file describes printing two or more sheets; and
each sheet of the two or more sheets omits a quality-control strip.

12. The computer-implemented method of claim 1, further comprising:
after printing the print job, printing the calibration ink chart via the printer as a post-printing calibration sheet;
measuring a respective post-printed color of the calibration ink chart on the post-printing calibration sheet via the spectrophotometer;
comparing the measured respective post-printed color to a respective calibration color of the calibration colors;
based on the comparison between the measured respective preprinted color to the respective calibration color, identifying the print job as correct or incorrectly colored.

13. The computer-implemented method of claim 1, wherein:
comparing the measured respective preprinted color to the respective calibration color generates a color delta value, the color delta value representing the amount of difference between the respective preprinted color and the respective calibration color as determined by a spectrophotometer;
the adjustment of the printer to decrease the difference between the measured respective preprinted color and the respective calibration color occurs based on the comparison between the measured respective preprinted color to the respective calibration color and the color delta value exceeding a minimum tolerance threshold value.

14. The computer-implemented method of claim 1, wherein the adjustment of the printer to decrease the difference between the measured respective preprinted color and the respective calibration color targets an intermediary color between the measured respective preprinted color and the respective calibration color.

15. The computer implemented method of claim 1, further comprising:
updating a printer color profile of the printer based upon the adjustment decreasing the difference between the measured respective preprinted color and the respective calibration color.

16. The computer-implemented method of claim 1, wherein the adjustment decreasing the difference between the measured respective preprinted color and the respective calibration color is performed by a neural network.

17. A printing calibration system, comprising:
a printer;
a processor, coupled to the printer;
a spectrophotometer, coupled to the processor;
a memory, coupled to the processor; and
machine-readable instructions embodying programming in the memory, wherein execution of the programming by the processor configures the printing calibration system to perform functions, including functions to:
receive a print job file, the print job file including one or more print colors;
prepare a calibration ink chart, the calibration ink chart including one or more calibration colors;
print the calibration ink chart via the printer as a preprinting calibration sheet;
measure a respective preprinted color of the preprinted colored ink on the preprinting calibration sheet via the spectrophotometer;
compare the measured respective preprinted color to a respective calibration color of the calibration colors;
based on the comparison between the measured respective preprinted color to the respective calibration color, adjust the printer to decrease the difference between the measured respective preprinted color and the respective calibration color; and
print a print job as described by the print job file.

18. The printing calibration system of claim 17, wherein:
the printer has a sheet width;
the spectrophotometer is configured to scan a scanner area narrower than the sheet width.

19. The printing calibration system of claim 17, wherein:
the spectrophotometer is fixed in position.

20. The printing calibration system of claim 17, wherein:
the function to compare the measured respective preprinted color to the respective calibration color generates a color delta value, the color delta value representing the amount of difference between the respective preprinted color and the respective calibration color as determined by a spectrophotometer; and
the function making the adjustment of the printer to decrease the difference between the measured respective preprinted color and the respective calibration color occurs based on the comparison between the measured respective preprinted color to the respective calibration color and the color delta value exceeding a minimum tolerance threshold value.
